(19) United States
(12) Patent Application Publication
(10) Pub. No.: US 2007/0244818 A1
(43) Pub. Date: Oct. 18, 2007

(54) Contents Distribution Control System, Distribution Scheduling Method of The Same, Communication Terminal and Computer Program of The Same

(76) Inventors: Keisuke Tsuji, Tokyo (JP); Yukio Abematsu, Yokohama-shi (JP); Mitsumasa Iwanaga, Tokyo (JP)

Correspondence Address: EDWARDS ANGELL PALMER & DODGE LLP, P.O. BOX 55874, BOSTON, MA, 02205, US

(21) Appl. No.: 11/596,964

(22) PCT Filed: Mar. 16, 2005
(86) PCT No.: PCT/JP05/04623

§ 371 Date: Nov. 17, 2006

(30) Foreign Application Priority Data
May 19, 2004 (JP) 2004-149193

(51) Int. Cl. G06Q 99/00

(52) U.S. Cl. 705/51

(57) ABSTRACT

A contents distribution control system calculates an estimated load of a Proxy 3 with respect to content to be distributed to a mobile wireless terminal 1 based on a throughput of the mobile wireless terminal 1, and has a DEC 5 which flattens or lessens a distribution schedule in order to prevent a total load on the Proxy 3 from being over a predetermined value based on both a traffic template prepared beforehand of the Proxy 3 and the estimated load.

### TECHNICAL FIELD

The present invention relates to a contents distribution control system, a distribution scheduling method, a communication terminal and a computer program of the same.

Priority is claimed on Japanese Patent Application No. 2004-149193, filed May 19, 2004, the content of which is incorporated herein by reference.

### BACKGROUND ART

The present invention relates to a contents distribution control system, its distribution scheduling method, a communication terminal and a computer program for realizing the contents distribution control system by using a computer.

In recent years, with respect to a mobile wireless terminal such as a cellular phone or the like, along with improving its performance and/or capacity, a mobile wireless terminal which can receive and/or transmit a large size movie file such as the content of a TV program has been realized.

Moreover, in recent years, users of the mobile wireless terminals have been able to see the contents of the TV program such as movies or motion pictures on-demand by using the Internet.

On the other hand, there is a well-known distribution system which, in a case in which data such as music data and/or the like is distributed to the terminals via a communication network, determines a distribution time schedule based on an average value of the number of distributions at each time period in the past, an upper limit of a maximum distribution performance of a distribution server per hour, the condition of traffic on network at each time period (calculated from continuously measured results of transmission rate/speed on network), and/or the like (for example, Japanese Unexamined Patent Application, First Publication No. H11-355346). In accordance with such a manner or a method, both a load distribution/balance of the distribution server which distributes data and effective distribution of data are aimed at.

However, in the above-described conventional system, there is a problem in that it is not possible to distribute as scheduled; and therefore, it is not possible to obtain sufficient effects because the distribution time schedule is determined without any considerations for data communication speed/rate of the terminals. There are some types of mobile wireless terminals which have lower performance and slower throughput. Moreover, the mobile wireless terminals are affected from the state of radio waves or wireless communication such as electric field intensity, fading and/or the like. Therefore, the throughput of the mobile wireless terminal greatly differs in accordance with its type and the state of radio waves or wireless communication. Due to such a problem, with respect to terminals which have different throughput, if the distribution time schedule of data is determined uniformly or equally, the time required for distributing data differs even though the amount of data is the same because the amount of data that it is possible to distribute in a certain time unit is respectively different among the terminals, and the accuracy of distribution schedule is lower.

An on-demand contents distribution service for movies and the like via the Internet is convenient for users; however, it increases the chance of traffic jams on the network in a situation in which the network is crowded. On the other hand, the traffic on the Internet greatly differs depending on time period (and slightly differs depending on days,) and is smaller especially from midnight to early morning; therefore, there is a problem of using network resources effectively.

If the broadcasting time of a program is predetermined like a generally used broadcasting service, viewers can receive and watch the broadcasted program at the time, record it with a video and playback/watch it later, and the like.

The present invention has been conceived in view of the problems above, and its object is to provide a contents distribution control system and distribution scheduling method therefore which can increase utilization efficiency, when the content is delivered in a time period of lower traffic (for example, a time period from midnight to early morning) on the communication network, by generating a distribution schedule which aims to flatten or lessen the traffic based on an estimated load calculated from differences of throughputs among the terminals, a size of the content, and/or the like.

Another object of the present invention is to provide a communication terminal which can be applied to the contents distribution control system of the present invention.

Another object of the present invention is to provide a computer program for realizing the contents distribution control system of the present invention by using a computer.

### DISCLOSURE OF THE INVENTION

A contents distribution control system of the present invention that distributes content to a communication terminal via a relay apparatus which has a predetermined operation performance, is characterized by including: an expected load calculation unit which calculates an expected load on the relay apparatus upon distributing the content that is scheduled to be distributed to the communication terminal based on a throughput of the communication terminal; and a distribution scheduling unit which flattens or lessens a distribution schedule in order to prevent a total load on the relay apparatus from being over a predetermined value, based on a traffic template of the relay apparatus and the estimated load on the relay apparatus.

The contents distribution control system of the present invention is characterized by an estimated load calculation unit which calculates the estimated load based on a throughput result of the communication terminal.

The contents distribution control system of the present invention is characterized by further including a throughput calculation unit which calculates a throughput result based on a contents distribution result sent to the communication terminal.

The contents distribution control system of the present invention is characterized by the throughput calculation unit which, every time the content is delivered to the communication terminal, records or stores the throughput result of the communication terminal after updating.

The contents distribution control system of the present invention is characterized by the distribution scheduling unit which, upon receiving a content update check request from the communication terminal, generates the distribution schedule for the next distribution and notifies of the time for conducting a next content update check request to the communication terminal.

The contents distribution control system of the present invention is characterized by the distribution scheduling unit which, in accordance with the distribution schedule, transmits a signal including an activation request of the communication terminal to the communication terminal.

The contents distribution control system of the present invention is characterized by an estimated load calculation unit which, based on a size of the content to be distributed and the throughput of the communication terminal, calculates the estimated load.

The contents distribution control system of the present invention is characterized by further including: a registered content information storing unit in which information of the content to be distributed to the communication terminal is stored; a registered content inconsistency detection unit which detects an inconsistency of registered content information by checking both the registered content information maintained by the communication terminal and the registered content information of the registered content information storing unit; and a registered content information synchronization unit which, upon detecting an inconsistency of the registered content information by the registered content inconsistency detection unit, transmits the registered content information of the registered content information storing unit to the communication terminal.

A communication terminal of the present invention that receives content distributed via a relay apparatus having a predetermined operation performance is characterized by including: a registered content storing unit in which information on the content to be distributed is stored; and a registered content synchronization unit which receives registered content information maintained by a contents distribution control system and updates registered information on the registered content storing unit.

A communication terminal of the present invention that receives content distributed via a relay apparatus having a predetermined operation performance is characterized by including: a memory rnanagement unit which assigns and reserves memory of a memory/storage unit in accordance with the size of the content to be distributed; and a content storing control unit which stores the distributed content at a memory area reserved by the memory management unit.

A distribution scheduling method of the present invention is a distribution scheduling method of a contents distribution control system which distributes content to a communication terminal via a relay apparatus which has a predetermined operation performance, and is characterized by including the steps of: preparing a traffic template beforehand; calculating an expected load on the relay apparatus upon distributing the content which is scheduled to be distributed to the communication terminal based on a throughput of the communication terminal; and flattening or lessening a distribution schedule in order to prevent a total load on the relay apparatus from being over a predetermined value, based on the traffic template of the relay apparatus and the estimated load on the relay apparatus.

A computer program product of the present invention is a computer program product for generating a distribution schedule of a contents distribution control system which distributes content to a communication terminal via a relay apparatus which has a predetermined operation performance, and which is characterized by including: a function of calculating an expected load on the relay apparatus upon distributing the content to be distributed to the communication terminal based on a throughput of the communication terminal; and a function of flattening or lessening a distribution schedule in order to prevent a total load on the relay apparatus from being over a predetermined value, based on both a traffic template prepared beforehand of the relay apparatus and the estimated load on the relay apparatus.

In accordance with the present invention, it is possible to calculate an estimated load which will affect a relay apparatus at the time of a next contents distribution based on a throughput in the past and a size of the content to be distributed and to schedule delivering along with flattening or lessening the total load which is expected to affect the relay apparatus so as not to exceed a predetermined amount. By applying such a system, when the contents are delivered by using the time period of lower traffic on the communication network (for example, from midnight to early morning), it is possible to increase the utilization efficiency of the network.

### BRIEF DESCRIPTION OF THE DRAWINGS

FIG. 1 is a block diagram showing a constitution of a content distribution system of a first embodiment of the present invention.

FIG. 2 is a block diagram for explaining a Proxy 3 and a log server 4 shown in FIG. 1.

FIG. 3 is a block diagram for explaining a DEC 5 shown in FIG. 1.

FIG. 4 is a first figure for explaining a distribution scheduling method of the present invention.

FIG. 5 is a second figure for explaining a distribution scheduling method of the present invention.

FIG. 6 is a figure of an outline sequence of a distribution operation of the contents distribution control system shown in FIG. 1.

FIG. 7 is a figure showing an example of a constitution of: user information 101 which is recorded/stored in the DEC 5; program information 102; Proxy traffic information 103; and mobile wireless terminal type information 104.

FIG. 8 is a basic concept for explaining a relationship of the present invention between an estimated request number and estimated retention time.

FIG. 9 is a third figure for explaining a distribution scheduling method of the present invention.

FIG. 10 is a first sequence figure for explaining one embodiment of a contents distribution control system of the present invention.

FIG. 11 is a second sequence figure for explaining one embodiment of a contents distribution control system of the present invention.

FIG. 12 is a third sequence figure for explaining one embodiment of a contents distribution control system of the present invention.

FIG. 13 is a fourth sequence figure for explaining one embodiment of a contents distribution control system of the present invention.

FIG. 14 is an outline sequence of a distribution operation of the contents distribution control system shown in FIG. 1.

### BEST MODE FOR CARRYING OUT THE INVENTION

Hereinafter, preferred embodiments of the present invention are described along with referring to figures. It should be understood that the present invention is not limited by the embodiments below, and it is possible to, for example, combine constitutional elements of the embodiments appropriately.

Hereinafter, referring to figures, one embodiment of the present invention is explained.

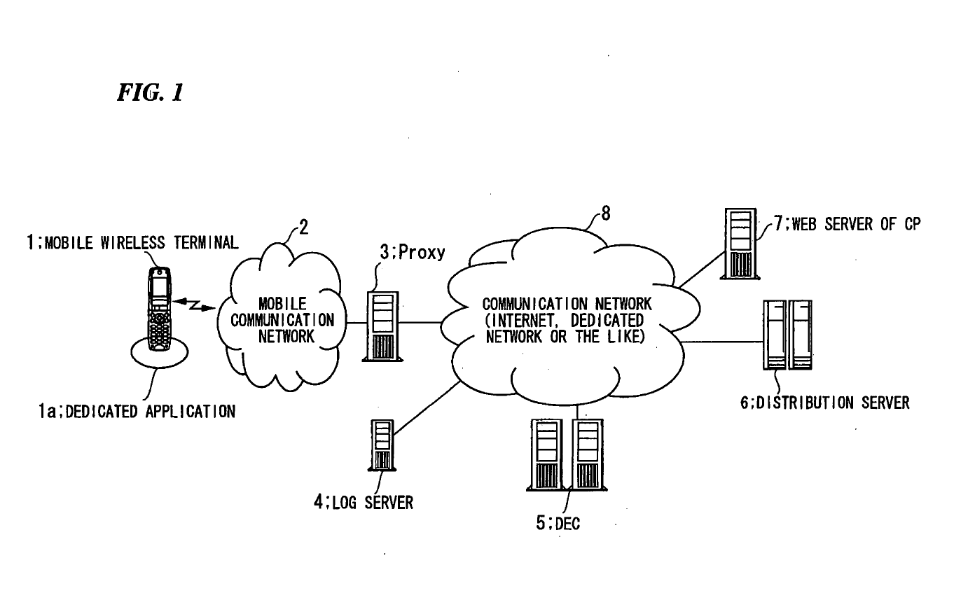

FIG. 1 is a block diagram showing a constitution of a content distribution system of a first embodiment of the present invention. In this contents distribution control system, a program which is constituted from voice, images (movies or still images), text, and/or the like is distributed. In FIG. 1, a mobile wireless terminal 1 which is a subscriber terminal of a mobile communication network 2, is connected to the mobile communication network 2 and is possible to operate data communication (such as e-mail, Web access, downloading of data) via the Internet, playback of a downloaded program, and/or the like. An application 1a which is dedicated to a program distribution service provided by the contents distribution control system is installed in the mobile wireless terminal 1.

A proxy 3 is an apparatus which relays Web access from the mobile wireless terminal 1. This Web access includes access to a distribution service of the present invention and other accesses. A log server 4 is an apparatus which collects or records traffic data of the Proxy 3. A DEC (DElivery Controller: a distribution control apparatus) 5 is an apparatus (a contents distribution control system) which controls CP (content provider) information, program information and user information of the distribution service, and manages a distribution schedule to the mobile wireless terminal 1 and distribution results.

A distribution server 6 distributes the program provided by the distribution service to the mobile wireless terminal 1. A Web server 7 of the CP is a Web server of a provider who provides the program in the distribution service and opens a Web page for registering and canceling the provided program. The Web page of the Web server 7 is linked from a Web page which is a user interface or entrance of the DEC 5.

The Proxy 3, the DEC 5, the distribution server 6 and the Web server 7 are connected via a communication network 8. The communication network 8 is constituted from the Internet, dedicated networks, and the like. The log server 4 is connected to the Proxy 3 and the DEC 5.

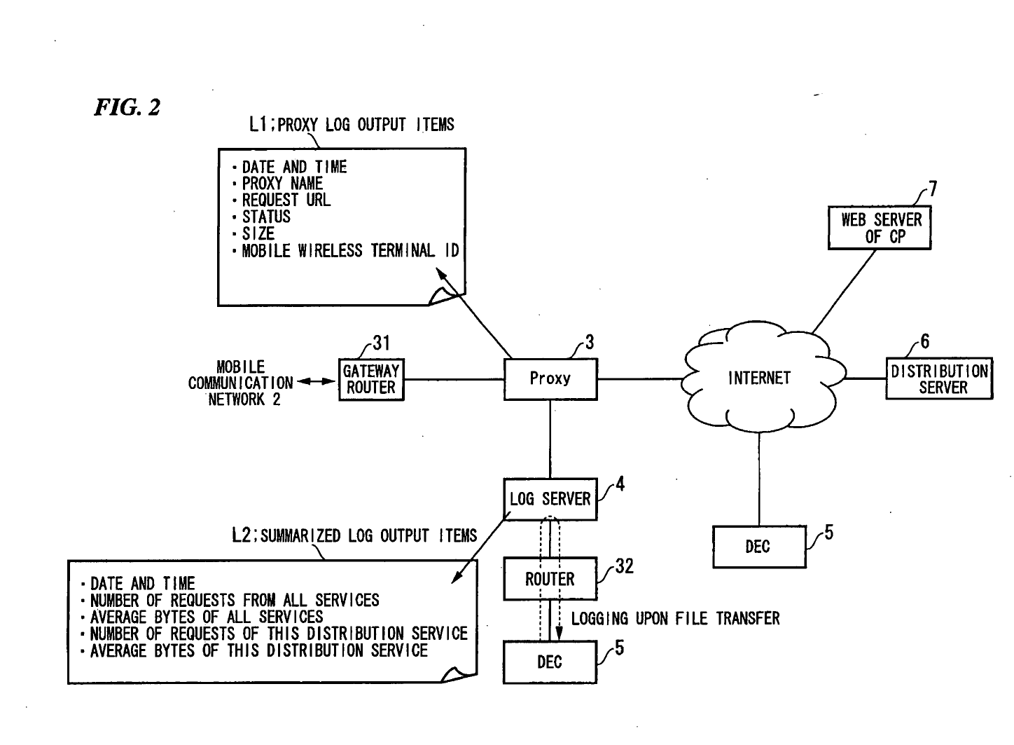

FIG. 2 is a block diagram for explaining the Proxy 3 and the log server 4. In FIG. 2, the Proxy 3 conducts a relay operation of a communication session when the mobile wireless terminal 1 operates Web access. The Proxy 3 outputs log data including a log output item L1 to the log server 4. The Proxy 3 connects to the mobile communication network 2 via a G/W router 31. Moreover, the Proxy 3 connects to the distribution server 6 via the Internet.

The log server 4 collects the log data from the Proxy 3 and operates logging of all requests which are passed through the Proxy 3. The log server 4 summarizes the logging data and calculates or generates log data including a summarized log output item L2. The DEC 5 obtains this log data by applying a file transfer via the router 32.

The log data transferred to the DEC 5 includes, for example, summarized results of the log data of the Proxy 3 generated in a day. With respect to the summarized results, for example, a summarizing unit is one minute, and summarizing items are: a number of requests of all services and an average number of transferred bytes of all services; a number of requests of the distribution service and an average number of transferred bytes of the distribution service; and the like.

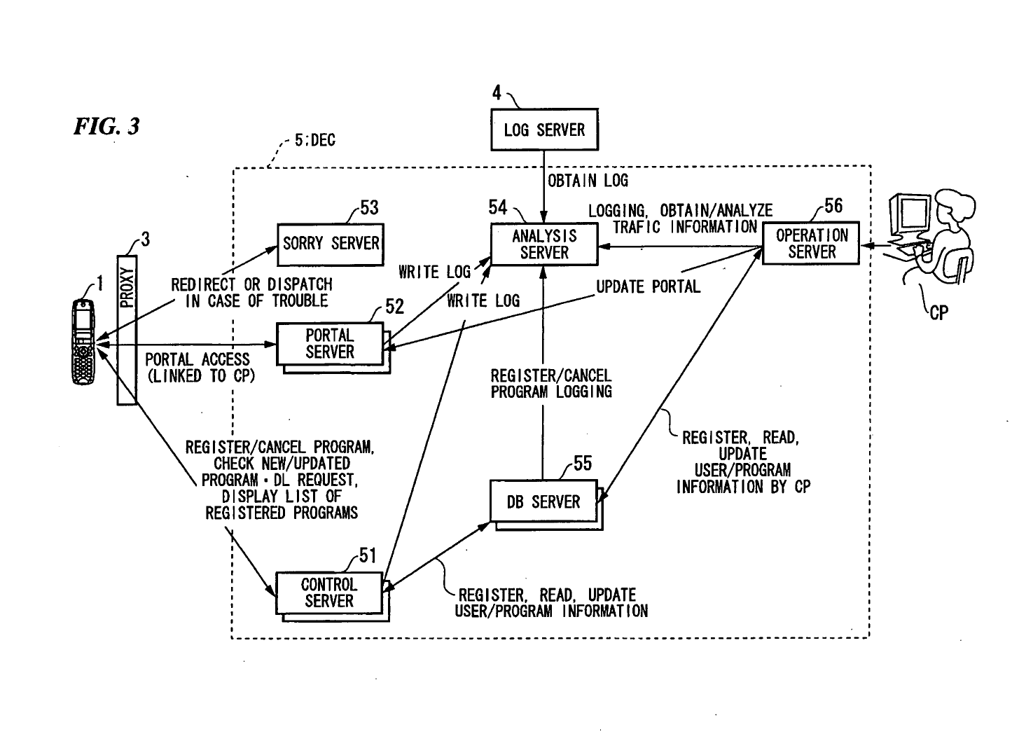

FIG. 3 is a block diagram for explaining the DEC 5. In FIG. 3, a control server 51, based on a regulated interface to the mobile wireless terminal 1, controls in order to operate a registration of a program, a cancellation, a distribution and a display of a list of registered programs. A portal server 52 is a Web server which controls sites for the distribution service and which includes a link to the Web server 7 of the CP. It is possible to access to the control server 51 and the portal server 52 from the mobile wireless terminal 1. In a case in which it is not possible to access to the control server 51 and the portal server 52, access from the mobile wireless terminal 1 is redirected, delivered or dispatched to a Sorry server 53, and the Sorry server 53 notifies that it is impossible to access.

An analysis server 54 obtains log data from the log server 4 and stores the data as traffic analysis data. A database (DB) server 55 stores traffic information, CP information, program information, user information and the like. An operation server 56 realizes functions such as registering or updating the CP information from operation terminals, the program information, the user information (mobile wireless terminal information and the like) and the like for the system operator and the CP.

A delivery scheduling method of this embodiment is explained next.

In this contents distribution control system, a traffic template for distribution scheduling (hereinafter, traffic template) is provided beforehand. The distribution schedule is generated based on this traffic template.

A generation method of this traffic template is explained next.

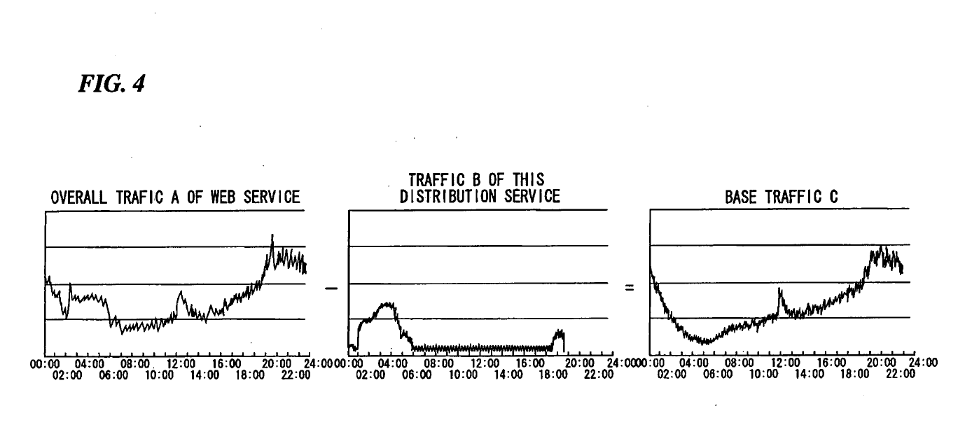

First, as shown in FIG. 4, base traffic C which is obtained by subtracting traffic B at the Proxy 3 corresponding to the distribution service from traffic A at the Proxy 3 corresponding to the overall Web service, is calculated. The traffic A of the overall Web service and the traffic B of the distribution service are obtained from the log data of the log server 4.

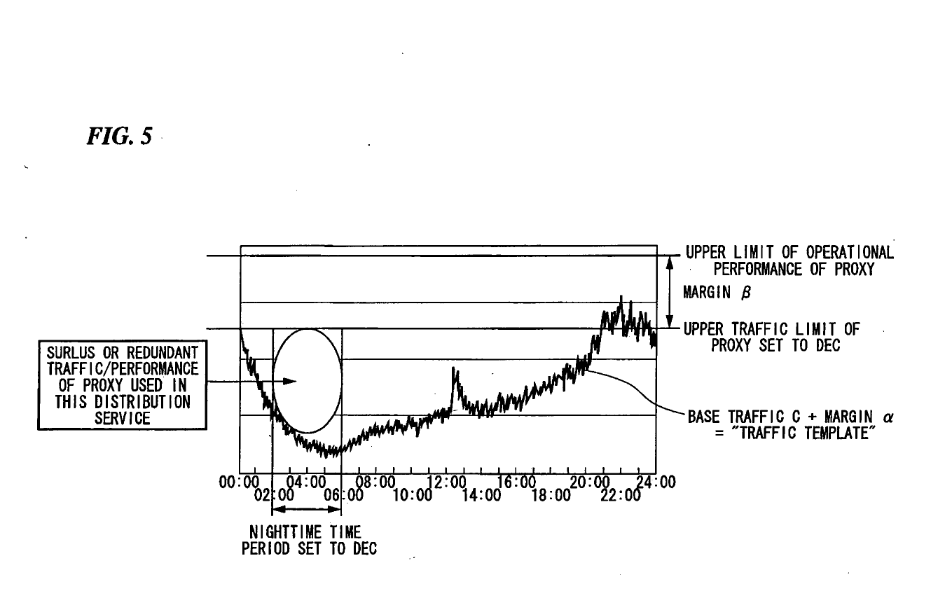

As shown in FIG. 5, the “template traffic” which is obtained by adding a margin a that indicates a later increase of the traffic to the base traffic C, is set to the DEC 5. The DEC 5 generates the distribution schedule based on the traffic template.

In an example of FIG. 5, a time period at nighttime (for example, a time period from 2 AM to 6 AM) which is time period of lower traffic is set as the time period for scheduling to the DEC 5. Moreover, a Proxy traffic upper limit which is obtained by subtracting a margin P from an upper limit of operational performance of the Proxy 3 is set to the DEC 5. These data which are set are maintained by the DB server 55 and the like. In accordance with such a manner/method/system, with respect to the DEC 5, it is possible to use a surplus or redundant traffic/performance of the Proxy 3 which is a difference between the traffic template and the Proxy traffic upper limit for the distribution service in the time period of nighttime (for example, from 2 AM to 6 AM).

The operation load per unit time of the Proxy 3 is proportionate to a number of requests per unit time received from the mobile wireless terminal 1. Therefore, it is possible to apply the number of requests received from the mobile wireless terminal 1 in the unit of time to an estimated load of the Proxy 3 per unit time.

It is possible that the DEC 5 applies a distribution band calculated in accordance with “number of requests×average transferred bytes” to the estimated load of the Proxy 3 per unit time.

Hereinafter, a case of applying the number of requests to the estimated load is explained.

The traffic template is checked and reviewed based on the log data of the log server at the proper/appropriate time and is updated if necessary.

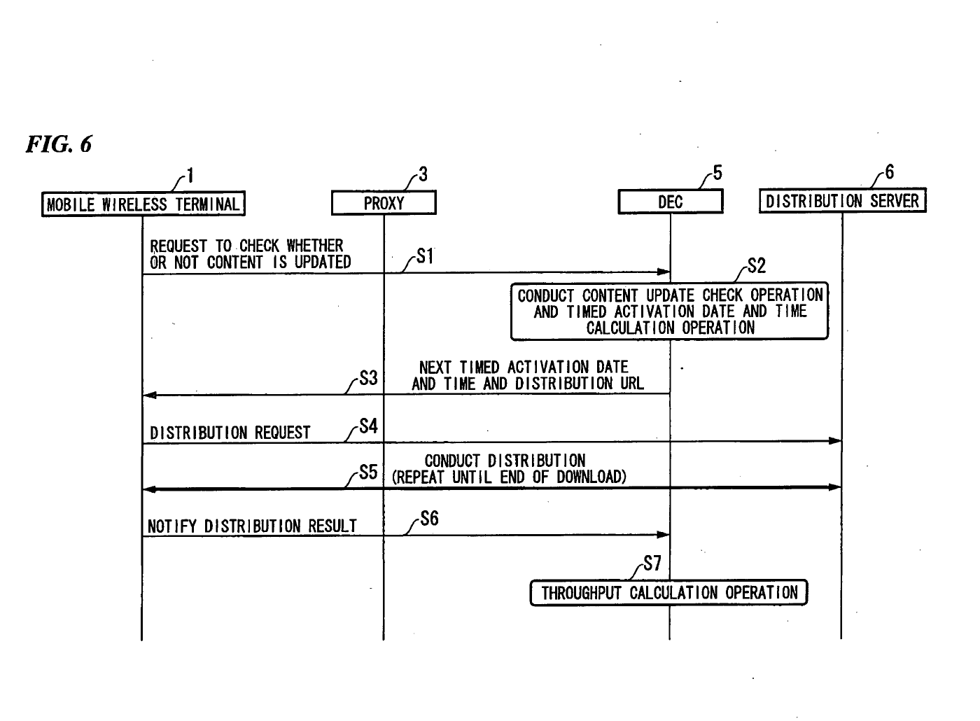

An operation of the delivery scheduling of the DEC 5 is explained next in reference to FIG. 6.

FIG. 6 is a figure of an outline sequence of a distribution operation of the contents distribution control system of this embodiment. In FIG. 6, at a predetermined time, the mobile wireless terminal 1, in order to issue a content update checking request, automatically requests by using a timer the activation/starting of a dedicated application program 1a on the DEC 5. After receiving such access from the mobile wireless terminal 1, the DEC 5 conducts both a content update checking operation and a next time and date calculation for a timed activation operation (step S2).

The next time and date calculation for the timed activation operation by the DEC 5 is explained below.

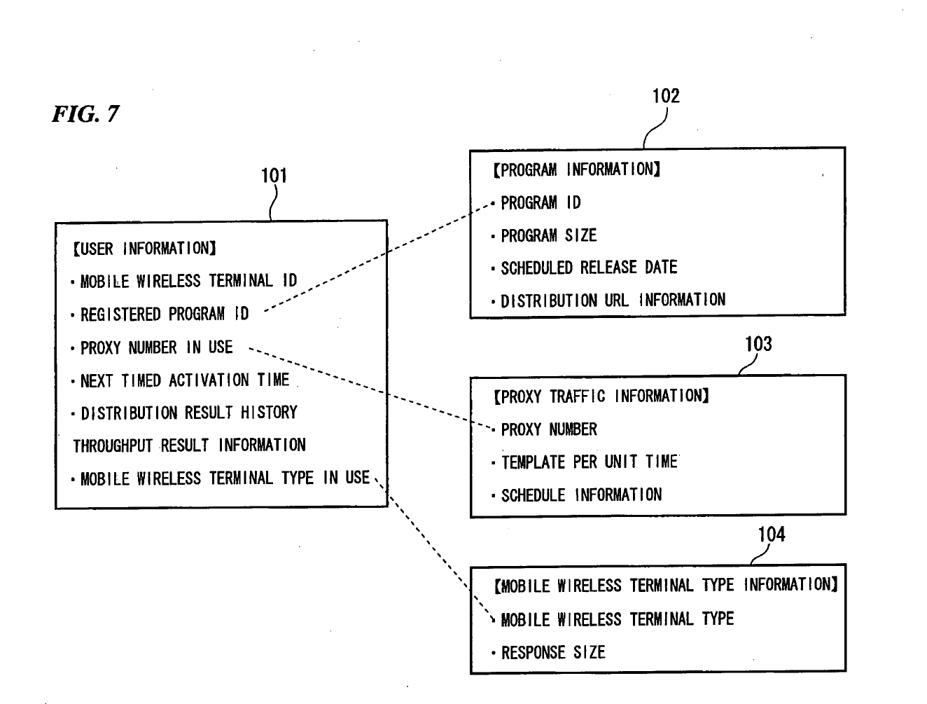

The DEC 5 includes the DB server 55 which stores, as shown in FIG. 7, user information 101, program information 102, Proxy traffic information 103, mobile wireless terminal type information 104, and the like. Based on these types of information 101-104, with respect to each user, the DEC 5 maintains information of registered programs (program ID, size of program file (program size), scheduled release date, URL of the distribution server 6 (distribution URL information), and the like), proxy traffic information, a response size of the mobile wireless terminal 1 (a number of received bytes per one request), distribution throughputs in the past (results and an average value of throughputs of latest 5 times (throughput result information)), and the like. As information of the traffic template, the Proxy traffic information includes a number of requests per unit time (for example, 1 minute) (a template per unit time).

Upon conducting the next time and date calculation for the timed activation operation, based on the file size of the registered program which will be sent to the user the next time and the response size, the DEC 5 calculates a total number of requests which will be sent to the mobile wireless terminal of the user upon distributing the file. For example, in a case in which the response size is 96 K bytes, in order to obtain a file of 3 M bytes, the mobile wireless terminal 1 should send the requests to the distribution server 6 at least 32 times.

“3 M bytes÷96 K bytes=32”, therefore, the total number of the requests=32.

Based on the file size for distributing the next time and the distribution throughput in the past, the DEC 5 calculates the required time for the next distribution.

For example, in a case in which a file of 3 M bytes is transmitted in accordance with the distribution throughput in the past “250 Kbps (250 K bit per one second)”, retention time=3 M bytes÷205 Kbps=120 seconds.

The DEC 5 calculates the number of requests per unit time (one minute) transmitted from the mobile wireless terminal 1.

For example, in a case in which the total number of requests is 32 and the retention time is 120 seconds, the number of requests/minute=32÷120 seconds×60=16. “The number of requests per unit time (1 minute)” calculated here is the estimated request number per the unit time (1 minute) which should be scheduled for the next scheduled time period and is loaded on the Proxy 3. The estimated request number is retained for the estimated retention time.

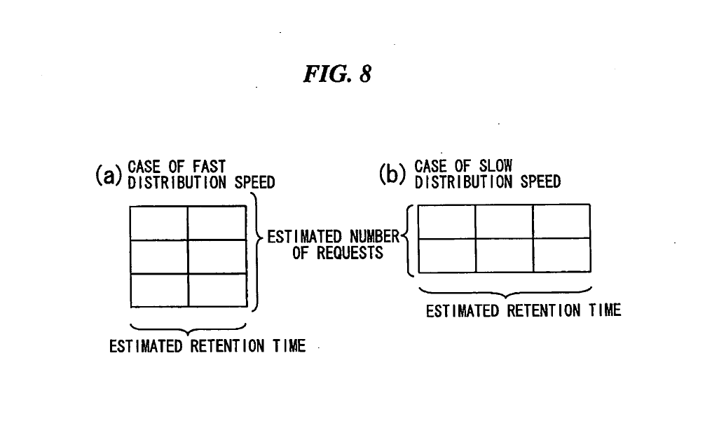

FIG. 8 is a basic concept for explaining a relationship between the estimated request number per unit time (1 minute) and the estimated retention time. A total estimated load required for transferring the file is calculated by multiplying the estimated request number per unit time and the estimated retention time. As shown in FIG. 8, even in a case in which the total request number is the same, if the throughput of the mobile wireless terminal 1 is large and the distribution speed is fast, compared to a case in which the throughput of the mobile wireless terminal 1 is small and the distribution speed is slow, the estimated retention time is short and the estimated request number per unit time is large.

Based on: an estimated total load which includes the calculated and estimated request number per unit time and the calculated and estimated retention time; the traffic template; and the scheduling condition including other users, the DEC 5 determines the next file distribution date and time (that is, the next date and time for timed activation of the mobile wireless terminal 1, and that is, the time when the mobile wireless terminal 1 will request the DEC 5 to check whether or not the content is updated).

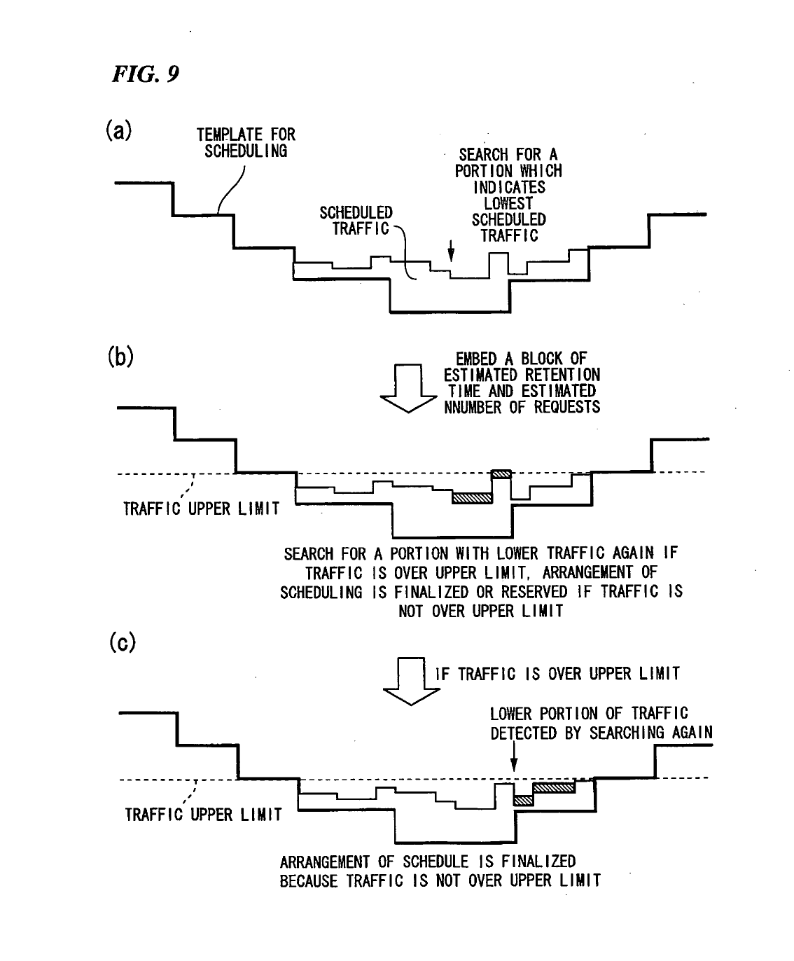

FIG. 9 is a basic concept for explaining a scheduling method of the estimated total load on the Proxy 3. FIG. 9(a) shows a state of scheduling at a next distribution time period. The DEC 5 determines the next distribution date based on the registered program information, obtains a scheduling table of a target day, and searches for a portion which indicates the lowest traffic which is already scheduled. The estimated total load is set or added onto the portion which is detected by searching. In this operation, in a case in which a portion of traffic is over the Proxy traffic upper limit after setting or adding (FIG. 9(b)), the search operation is conducted again and the estimated total load is set or added again (FIG. 9(c)). As a result, when it is possible to set or add the estimated total load without being over the Proxy traffic upper limit, an arrangement of the scheduling is finalized or reserved. A top of the time period which is set or arranged in this manner is determined as the next date and time for timed activation which will be notified to the mobile wireless terminal 1. This determined schedule is registered to the scheduling table for the delivery day. The scheduling table is stored in the DB server 55. Upon scheduling, the DEC 5 obtains the state of scheduling corresponding to the subject day in reference to the scheduling table.

It should be noted that it is possible to distribute the program accurately by scheduling a time period in which the Proxy 3 has enough and surplus performance or processing capacity with a higher priority.

In FIG. 6, the DEC 5 replies to both the calculated next date and time for timed activation and URL of the distribution server 6 which will distribute in this time to the mobile wireless terminal 1 (step S3). The mobile wireless terminal 1 memorizes or stores this next date and time for timed activation. The mobile wireless terminal 1 accesses the distribution server 6 based on the distribution URL and requests to distribute the program (step S4). After that, in response to the request from the mobile wireless terminal 1, the distribution server 6 distributes the program after dividing it in accordance with the specified size (step S5). This operation is repeatedly conducted until the download of the program is finished. The mobile wireless terminal 1 stores the program file in its memory after receiving it. The mobile wireless terminal 1 has a function to playback the stored program file. Therefore, the user can playback the program file stored in the mobile wireless terminal 1 when the user prefers without connecting to the network.

When the distribution in this time is successfully finished, the mobile wireless terminal 1 notifies a size of the received file (number of received Bytes) as a distribution result to the DEC 5 (step S6). When this distribution result is received, the DEC 5 calculates a throughput of this time (step S7). In this throughput calculation operation, the time required for distribution is calculated based on the distribution start time and distribution end time in this time. The throughput of this time is calculated by dividing the number of received bytes by the distribution required time. The throughput result information of the user in this time is updated by applying the throughput of this time. The DEC 5, for example, with respect to each user, maintains both the throughputs of previous 10 times and an average throughput of specified times of operations (for example, previous 5 times).

It should be noted that it is possible to notify the number of received bytes of the mobile wireless terminal 1 to the DEC 5 for calculating the throughput even if the distribution fails.

One example of the above-described embodiment of the contents distribution control system is explained.

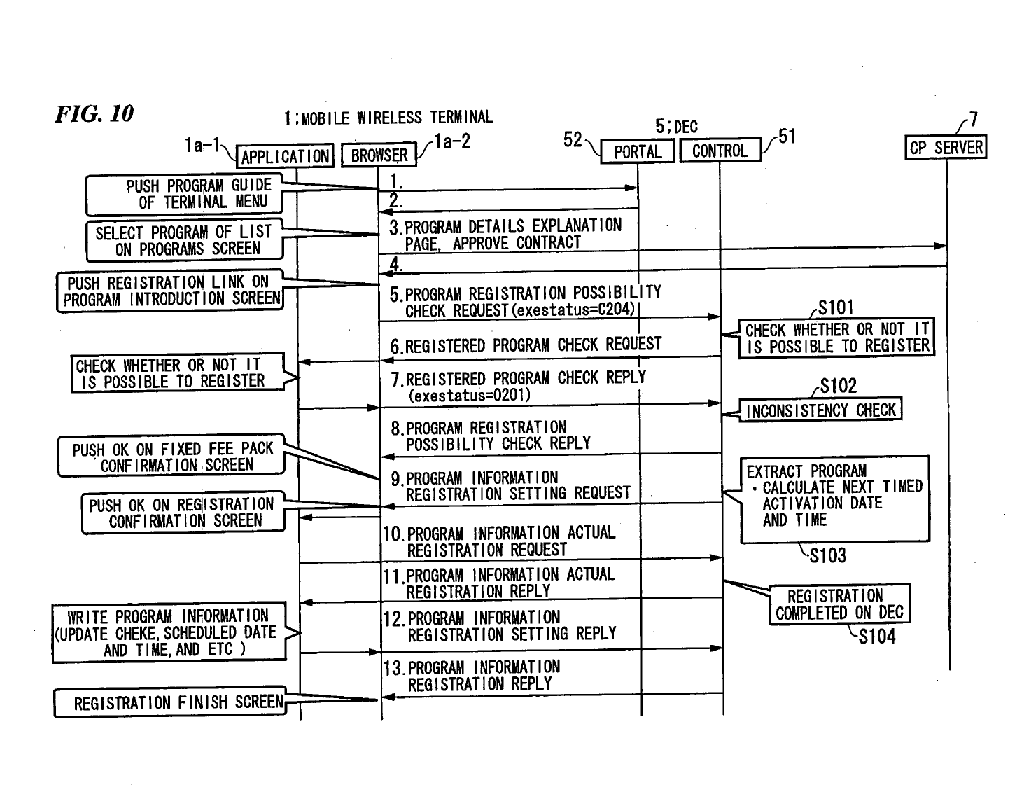

FIGS. 10-13 are sequence figures for explaining the example of the contents distribution control system of the present invention.

First, referring to FIG. 10, an operation of registering the program is explained.

In FIG. 10, in accordance with the user's operation, the mobile wireless terminal 1 requests the control server 51 of the DEC 5 via the desired Web server 7 (hereinafter, CP server 7) to register the program. Therefore, the control server 51 operates a registering possibility check (step S101). In this registering possibility check, checking of, such as, whether or not it is in a range of a possible registration number, whether or not the mobile wireless terminal 1 has sufficient memory for the size of the program file in this time, and/or the like are operated. Moreover, whether or not there is an inconsistency between the registered programs maintained by the mobile wireless terminal 1 and the registered programs of the mobile wireless terminal 1 maintained by the DEC 5 is checked (step S102). Here, if an inconsistency is detected, the program information (program ID and the like) of the DEC 5 is transmitted to the mobile wireless terminal 1 and the program information of the mobile wireless terminal 1 is adjusted so as to synchronize with the DEC 5. By synchronizing the registered program ID maintained in both the mobile wireless terminal 1 and the DEC 5, it is possible to prevent distributing an incorrect program beforehand and it is possible to operate in accordance with the distribution schedule generated by the DEC 5.

If no inconsistencies are detected, the control server 51 extracts the program information, calculates the next date and time for timed activation (step S103), transmits this next date and time for timed activation and a program size to the mobile wireless terminal 1, and requests to set a program information registration. This next date and time for timed activation is a date and time of the content check request at the mobile wireless terminal.

When a registration button is pushed in accordance with the user's operation, the program information including the program ID, the program size, the next date and time for timed activation, and the like which is notified by the DEC 5 is written onto the memory. It should be noted that the written information is still not valid at this step, and the written information is validated when a program information actual registration reply is received from the control server 51. In accordance with such a manner, the mobile wireless terminal 1 assigns and reserves a sufficient amount of memory from its memory for storing the program file. In such a manner, by assigning and reserving memory of the mobile wireless terminal 1 corresponding to the program size beforehand, it is possible to prevent distribution errors because of a lack of memory of the mobile wireless terminal 1 beforehand and to conduct operations in accordance with the distribution schedule generated by the DEC 5.

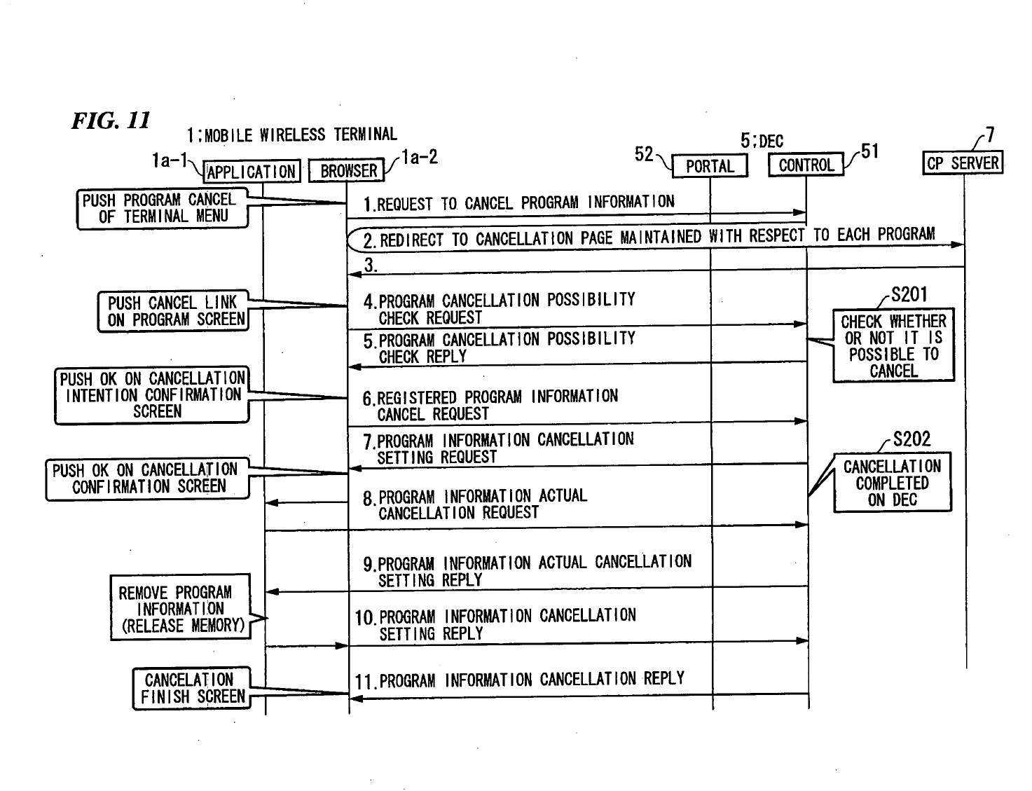

An operation of canceling of a program is explained next in reference to FIG. 11.

In FIG. 11, the mobile wireless terminal 1 requests the control server 51 to cancel the registration of the program in accordance with the user's operation. In this operation, the mobile wireless terminal 1 accesses a cancellation page of the CP server 7 in accordance with a redirection of the control server 51. Upon receiving a cancellation possibility check request from the mobile wireless terminal 1, the control server 51 checks whether or not it is possible to cancel (step S201) and replies with a check result to the mobile wireless terminal 1. If the check result indicates that it is possible to cancel, the control server 51 transmits a cancel setting request to the mobile wireless terminal 1 and finishes the cancellation on the DEC 5. The mobile wireless terminal 1 deletes the corresponding program information which is maintained by the mobile wireless terminal 1 itself, and releases the memory assigned to the program file. The mobile wireless terminal 1 transmits a response for setting to the control server 51 and finishes the cancellation.

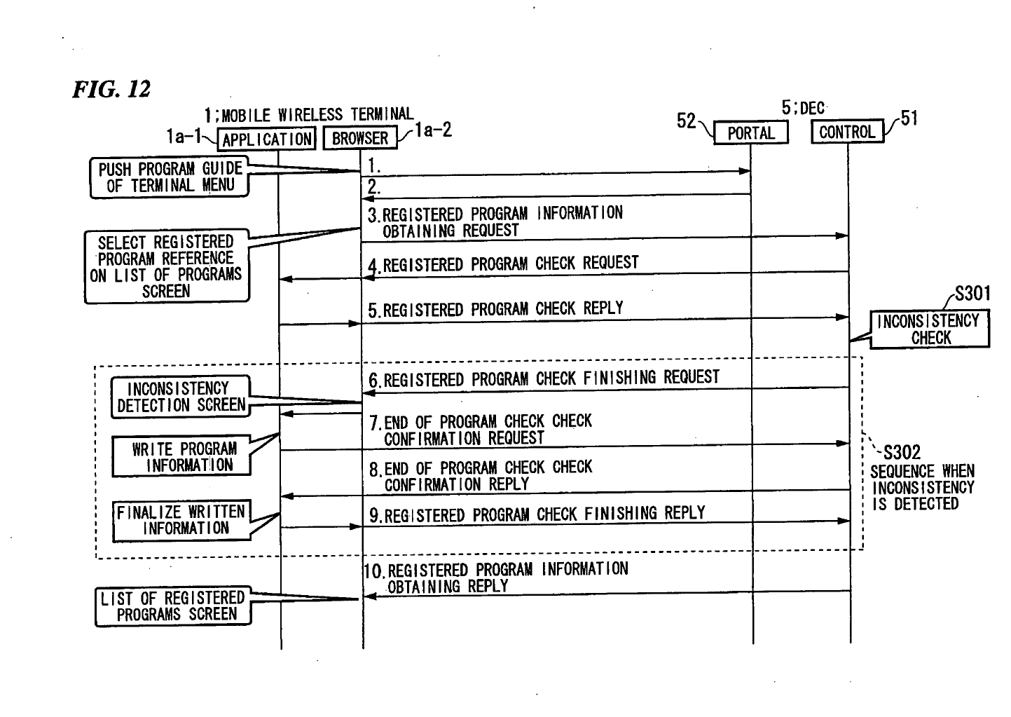

Referring to FIG. 12, an operation of displaying a list of the registered programs is explained.

In FIG. 12, the mobile wireless terminal 1 requests the control server 51 to obtain the registered program information via the Web page of the portal server 52 in accordance with the user's operation. In this operation, the control server 51 checks whether or not there is an inconsistency between the registered programs maintained by the mobile wireless terminal 1 and the registered programs of the mobile wireless terminal 1 maintained by the DEC 5 (step S301). Here, if an inconsistency is detected, maintained contents of the registered programs of the DEC 5 are transmitted from the control server 51 to the mobile wireless terminal 1 and the contents of the registered programs of the mobile wireless terminal 1 are adjusted so as to synchronize with the DEC 5 (step S302). A list of the registered programs included in this registered program information is displayed on a screen of the mobile wireless terminal 1.

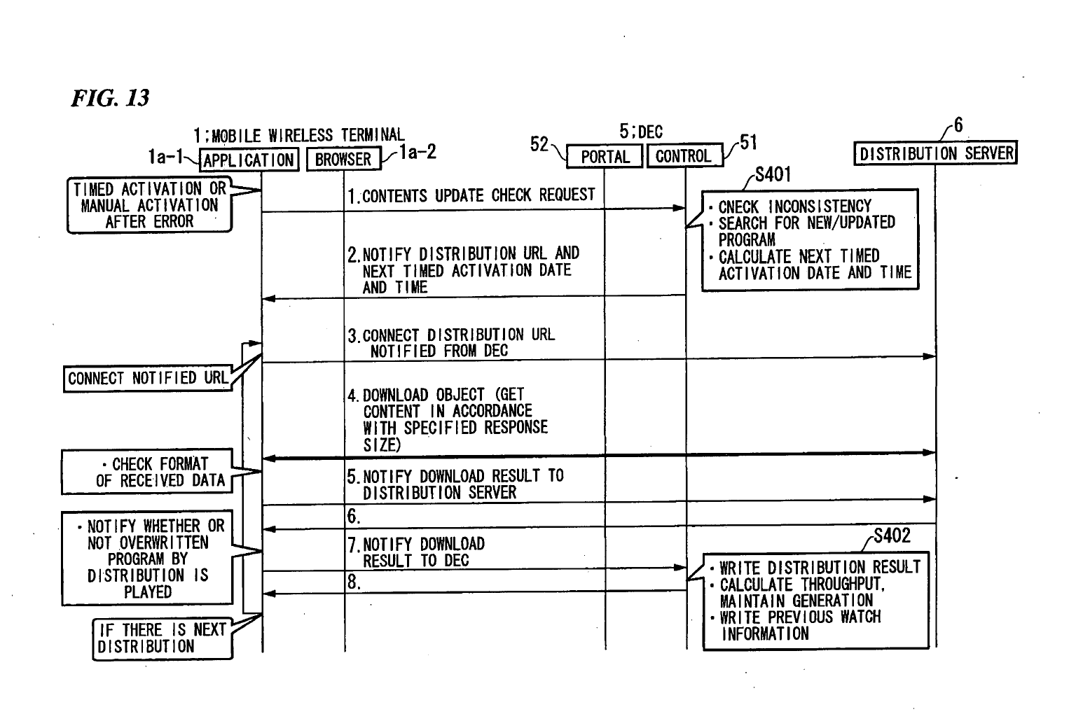

An operation of distributing the program is explained next in reference to FIG. 13.

In FIG. 13, the mobile wireless terminal 1 accesses the control server 51 at a timed activation date and time after being activated by the timer. By conducting this access, the control server 51 checks whether or not there is an inconsistency between the registered programs with respect to the mobile wireless terminal 1, and if there is no inconsistency, the control server 51 checks whether or not there is a new or updated program and calculates the next timed activation date and time (step S401). The control server 51 sends the URL for distribution in this time and the next timed activation date and time to the mobile wireless terminal 1. It should be noted that, if there is no new program, the control server 51 notifies the next timed activation date and time; however, the URL for distribution is not sent. If an inconsistency of the registered programs is detected, maintained contents of the registered programs of the DEC 5 are transmitted to the mobile wireless terminal 1 and the contents of the registered programs of the mobile wireless terminal 1 are adjusted so as to synchronize with the DEC 5. In this case, the control server 51 notifies the next timed activation date and time; however, the URL for distribution is not sent even in a case in which there is a new program.

The mobile wireless terminal 1 accesses the distribution server 6 by using the replied URL and requests to download the program in accordance with its response size. The downloaded program is written into the memory assigned for storing the program inside the mobile wireless terminal. When this download is finished, together with a download result in this time, the mobile wireless terminal 1 notifies the control server 51 whether or not the previously downloaded program which is overwritten because of distribution is played once at least. In accordance with this reply, the control server 51 records the distribution result, calculates the throughput of this time, updates the throughput result information of the user, and records whether or not the previous program has been watched (step S402).

As described above, in this embodiment, the expected load on the Proxy 3 upon distributing the program next time is calculated based on the distribution throughput in the past of the mobile wireless terminal. It is possible to schedule so as to distribute and flatten or lessen the total load on the Proxy 3 so as not to be over a predetermined amount. By applying such a manner/system, when the contents are delivered by using a time period of lower traffic on the communication network (for example, from midnight to early morning), it is possible to increase the utilization efficiency of the network.

In nighttime period, there is a high possibility that the users are sleeping and the mobile wireless terminals are not moved or brought; therefore, a state of wireless communication is stable. Therefore, in a time period from midnight to morning before the user starts moving, the program is distributed accurately and is stored in the terminal; therefore, it is possible to realize the appropriate program distribution for the user's action or movement.

It is possible to apply a special hardware in order to implement the DEC 5 of this embodiment, or it is possible as well to constitute the DEC 5 by applying a generally used computer system and by executing a program for realizing each function of the DEC 5 shown in FIG. 3.

It should be noted that the DEC 5 is connected to peripheral equipment such as an input apparatus, a display apparatus, and the like (not shown in figures). Here, the input apparatus means a device such as a keyboard, a mouse, and the like. The display apparatus means a CRT (Cathode Ray Tube), a liquid crystal display apparatus, and the like.

It is possible for the peripheral equipment to be directly connected to the DEC 5 or connected via a communication line.

It is possible for the program for realizing the function of the DEC 5 shown in FIG. 3 to be stored or recorded in a computer-readable medium, so that the computer reads the program stored or recorded in the medium, and the program is executed in order to conduct the distribution scheduling operation. It should be noted that the “computer system” here can include an OS and hardware such as peripheral equipment.

In a case in which the “computer system” can use a WWW system, the computer system includes a homepage environment (or an environment to display).

The “computer-readable medium” means a rewritable nonvolatile memory such as a flexible disc, a magneto-optical disc, a ROM, a flash memory, and the like, a portable medium such as a CD-ROM, a storage device such as a hard disc set inside the computer system.

Moreover, “computer readable medium” includes a volatile memory (such as a DRAM (Dynamic Random Access Memory)) inside the computer systems used for a server or a client to which the programs are transmitted via a network like the Internet or a communication line like a telephone line, which saves the programs for a certain time period.

The program above can be transmitted from the computer storing this program in the storage apparatus or the like via a transmission medium or via transmission waves in the transmission medium to another computer system. “Transmission medium” transmitting the program is a medium such as a network (communication network) like the Internet or a communication line (line) like a telephone line that has a function to transmit information.

It is possible for the above program to be a program for realizing a part of the above-described functions. Moreover, it is possible for the program to be a so-called difference file (difference program) which realizes the above functions by being combined with a program already stored in the computer.

The embodiment of the present invention is explained above, however, a concrete constitution of the present invention is not considered to be limited by the embodiments above, and the present invention includes constitutional modifications if they are inside the fundamental theory of the present invention.

For example, the present invention can be applied to a service for automatically distributing content periodically from a distribution center to a user terminal.

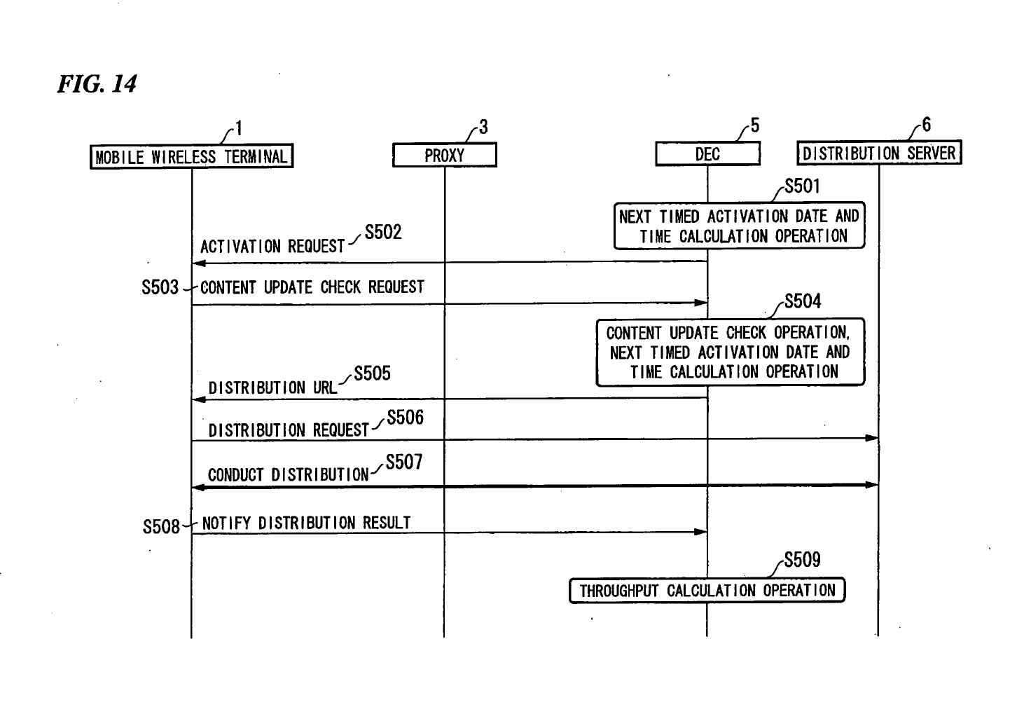

Apart from FIG. 6, as shown in FIG. 14, it is possible for the DEC 5 to access the mobile wireless terminal 1 at a previously calculated time in order to request the activation.

The DEC 5, by conducting the scheduling operation, calculates and manages the next timed activation date and time of the respective mobile wireless terminals 1. The DEC 5 operates the timed activation operation at the calculated time (step S501) and requests activation of the mobile wireless terminal 1 (step S502). The mobile wireless terminal 1, in accordance with the request as a trigger, requests the DEC 5 to check the update of the content (step S503). The DEC 5 calculates and stores/memorizes the next timed activation date and time after conducting the content update checking operation (step S504) and transmits the URL of the distribution server 6 which distributes in this time to the mobile wireless terminal 1 (step S505). The following access operations (steps S506-S509) from the mobile wireless terminal 1 to the distribution server 6 are the same as above.

### INDUSTRIAL APPLICABILITY

In accordance with the present invention, it is possible to calculate the estimated load which will affect a relay apparatus at the time of a next contents distribution based on a throughput of a communication terminal (for example, the mobile wireless terminal) in the past and the size of the content and to schedule delivering along with flattening or lessening the total load which is expected to affect the relay apparatus so as not to exceed a predetermined amount. By applying such a manner/system, when the contents are delivered by using a time period of lower traffic on the communication network (for example, from midnight to early morning), it is possible to increase the utilization efficiency of the network.

1. A contents distribution control system which distributes content to a communication terminal via a relay apparatus which has a predetermined operation performance, comprising:
an expected load calculation unit which calculates an expected load on the relay apparatus upon distributing the content that is scheduled to be distributed to the communication terminal based on a throughput of the communication terminal; and
a distribution scheduling unit which flattens or lessens a distribution schedule in order to prevent a total load on the relay apparatus from being over a predetermined value, based on a traffic template of the relay apparatus and the estimated load on the relay apparatus.

2. The contents distribution control system according to claim 1, wherein the estimated load calculation unit calculates the estimated load based on a throughput result of the communication terminal.

3. The contents distribution control system according to claim 2, further comprising
a throughput calculation unit which calculates a throughput result based on a contents distribution result sent to the communication terminal.

4. The contents distribution control system according to claim 3, wherein
the throughput calculation unit, every time the content is delivered to the communication terminal, records or stores the throughput result of the communication terminal after updating.

5. The contents distribution control system according to claim 4, wherein
the distribution scheduling unit, upon receiving a content update check request from the communication terminal, generates the distribution schedule for the next distribution and notifies of time for conducting a next content update check request to the communication terminal.

6. The contents distribution control system according to claim 5, wherein
the distribution scheduling unit, in accordance with the distribution schedule, transmits a signal including an activation request of the communication terminal to the communication terminal.

7. The contents distribution control system according to one of claims 1-6, wherein
the estimated load calculation unit, based on a size of the content to be distributed and the throughput of the communication terminal, calculates the estimated load.

8. The contents distribution control system according to one of claims 1-7, further comprising:
a registered content information storing unit in which information of the content to be distributed to the communication terminal is stored;
a registered content inconsistency detection unit which detects an inconsistency of registered content information by checking both the registered content information maintained by the communication terminal and the registered content information of the registered content information storing unit; and
a registered content information synchronization unit which, upon detecting an inconsistency of the registered content information by the registered content inconsistency detection unit, transmits the registered content information of the registered content information storing unit to the communication terminal.

9. A communication terminal which receives content distributed via a relay apparatus having a predetermined operation performance, comprising:
a registered content storing unit in which information of the content to be distributed is stored; and
a registered content synchronization unit which receives registered content information maintained by a contents distribution control system and updates registered information on the registered content storing unit.

10. A communication terminal which receives content distributed via a relay apparatus having a predetermined operation performance, comprising:
a memory management unit which assigns and reserves memory of a memory/storage unit in accordance with size of the content to be distributed; and
a content storing control unit which stores the distributed content at a memory area reserved by the memory management unit.

11. A distribution scheduling method of a contents distribution control system which distributes content to a communication terminal via a relay apparatus which has a predetermined operation performance, comprising the steps of:
preparing a traffic template beforehand;
calculating an expected load on the relay apparatus upon distributing the content that is scheduled to be distributed to the communication terminal based on a throughput of the communication terminal; and
flattening or lessening a distribution schedule in order to prevent a total load on the relay apparatus from being over a predetermined value, based on the traffic template of the relay apparatus and the estimated load on the relay apparatus.

12. A computer program product for generating a distribution schedule of a contents distribution control system which distributes content to a communication terminal via a relay apparatus which has a predetermined operation performance, comprising:
a function of calculating an expected load on the relay apparatus upon distributing the content to be distributed to the communication terminal based on a throughput of the communication terminal; and
a function of flattening or lessening a distribution schedule in order to prevent a total load on the relay apparatus from being over a predetermined value, based on both a traffic template prepared beforehand of the relay apparatus and the estimated load on the relay apparatus.
